(19) United States
(12) Patent Application Publication
(10) Pub. No.: US 2007/0266444 A1
(43) Pub. Date: Nov. 15, 2007

(54) Method and System for Securing Data Stored in a Storage Device

(76) Inventor: Moshe Segal, Raanana (IL)

Correspondence Address: DANIEL J SWIRSKY, 55 REUVEN ST., BEIT SHEMESH, 99544, IL

(21) Appl. No.: 11/718,988

(22) PCT Filed: Dec. 1, 2005
(86) PCT No.: PCT/IL05/01295

§ 371 Date: May 10, 2007

Related U.S. Application Data
(60) Provisional application No. 60/632,531, filed on Dec. 3, 2004.

(51) Int. Cl. H04L 9/32

(52) U.S. Cl. 726/27

(57) ABSTRACT

A method and system for securing data stored in a secured partition of a storage device coupled to a computer having an insecure operating system that is subservient to a secure operating system operating on the computer. When access to the secured partition is detected, the secure operating system is interrupted and the insecure operating system is preempted, thereby preventing the insecure operating system and tasks being subservient thereto from accessing the secured partition.

### FIELD OF THE INVENTION

This invention relates to security of data. More specifically the invention relates to a method and system for securing data stored in a storage device.

### BACKGROUND OF THE INVENTION

Computer security is an open issue that bothers society. Hostile software such as Viruses, Trojan horses or Worms continues to pose a severe threat to the safety and integrity of information stored and managed by computers. Hostile software continues to destroy computers, steal and destroy sensitive information that exists in private and corporate computers, causing severe damage. In addition, the possibility of cyber terror activity should not be ignored.

One known exemplary form of attack is known as “buffer overflow”. Buffer overflow occurs when data, constituting “written data”, is written into a buffer (i.e., a data storage area, e.g., in the computer's memory), wherein the written data exceeds the storage capacity of the buffer and “overflows” into another buffer that is not designated therefor.

Another recognized form of attack is known as Denial of Service (DoS), wherein a computer is flooded with information that is mostly useless. The useless information occupies the computer and hence prevents, or inhibits it from attending to other, useful tasks. A DoS attack commonly inhibits or denies communication services, however such attacks can also load the CPU (Central Processing Unit), resulting in buffer overflow, or even crashing the computer. Distributed Denial of Service (DDoS) is an attack wherein multiple (more than one) sources attack a single target, for example, wherein several computers attack a single computer via communications, or wherein several hostile programs attack the CPU etc.

It is appreciated that buffer overflow, DoS and DDoS are exemplary forms of attacks commonly used for attacking servers. However, common forms of attacks exist also for attacking client computers and/or standalone computers, such as viruses, Trojan horses etc., as mentioned above.

In addition, it is known in the art that in order to achieve higher levels of security, hardware needs to be implemented, and that software-only solutions are not adequate. This conclusion is specified, for example, in a document named “Trusted Subsystem Specification” by “Trusted Computing Platform Alliance” (TCPA).

Various approaches have been made in the past which have tried to cope with security threats. Some approaches coped with the threat at network level. For example, WO 97/00471 (“A system for securing the flow of and selectively modifying packets in a computer network”, CHECKPOINT SOFTWARE TECHN LTD., published 1997) discloses a system for controlling the inbound and outbound data packet flow in a computer network. By controlling the packet flow in a computer network, private networks can be secured from outside attacks in addition to controlling the flow of packets from within the private network to the outside world. A user generates a rule base, which is then converted into a set of filter language instructions. Each rule in the rule base includes a source, destination, service, and a rule which decides either to accept or reject the packet, and whether to log the event. The set of filter language instructions are installed and executed on inspection engines, which are placed on computers acting as firewalls. The firewalls are positioned in the computer network such that all traffic to and from the network to be protected is forced to pass through the firewall. Thus, packets are filtered as they flow into and out of the network in accordance with the rules comprising the rule base. The inspection engine acts as a virtual packet filtering machine which determines on a packet-by-packet basis whether to reject or accept a packet. If a packet is rejected, it is dropped. If it is accepted, the packet may then be modified. Modification may include encryption, decryption, signature generation, signature verification or address translation. All modifications are performed in accordance with the contents of the rule base. The system disclosed in WO 97/00471 provides additional security to a computer network by encrypting communications between two firewalls and between a client and a firewall. This permits the use of unsecured public networks in constructing a WAN (Wide Area Network) that includes both private and public network segments, thus forming a virtual private network.

It is known that fireballs, such as those described in WO 97/00471, are still vulnerable to breaks performed by hackers. In addition, when encrypted information is transferred in a virtual private network and/or in a private network segment operating in a WAN, security information such as keys can be intercepted by hostile parties, such as hackers. A hostile party can, for example, use intercepted security information for breaking into the network and/or intercepting information (including secured information) transferred thereby and/or encrypting secured information using the intercepted keys.

Other approaches have tried to manage security at the single processor level. Such an approach is presented in, for example, U.S. Pat. No. 6,795,905 (“Controlling accesses to isolated memory using a memory controller for isolated execution”, INTEL CORP, published 2004) that describes an access transaction generated by a processor that is configured using a configuration storage containing a configuration setting. The processor has a normal execution mode and an isolated execution mode. The access transaction has access information. Access to the configuration storage is controlled. An access grant signal is generated using the configuration setting and the access information. The access grant signal indicates if the access transaction is valid.

Another example is US 2004/139,346 (“Exception handling control in a secure processing system”, ADVANCED RISC MACH LTD., published 2004) that discloses a data processing system that includes a processor operable in a plurality of modes and either a secure domain or a non-secure domain, wherein at least one secure mode is a mode in the secure domain. The system also includes at least one non-secure mode being a mode in the non-secure domain, wherein when the processor executes a program in a secure mode the program has access to secure data which is not accessible when said processor operates in a non-secure mode. The processor is responsive to one or more exception conditions for triggering exception processing. The processor is also responsive to one or more parameters specifying which of the exceptions should be handled by a secure mode exception handler executing in a secure mode and which of said exceptions should be handled by an exception handler executing in a mode within a current one of the secure domains and the non-secure domain when that exception occurs.

There is thus a need in the art for a security method and system providing better security and, in addition, allowing protection of security information, such as encryption keys.

### SUMMARY OF THE INVENTION

It is an object of the invention to provide a high security method and system allowing protection of security information, such as encryption keys.

According to one aspect of the invention there is provided a method for securing data stored in a secured partition of a storage device coupled to a computer having an insecure operating system that is subservient to a secure operating system operating on the computer, the method comprising:

detecting access to the secured partition;

interrupting the secure operating system; and

responsive to said interrupting, preempting the insecure operating system and tasks being subservient thereto thereby preventing them from accessing the secured partition.

According to another aspect of the invention there is provided a security system for securing data stored in a secured partition of a storage device coupled to a computer having an insecure operating system that is subservient to a secure operating system operating on the computer, the security system comprising:

an access controller for detecting access to the secured partition;

an interrupt generator coupled to said access controller and being responsive to access detection for generating an interrupt for interrupting the secure operating system; and

an interrupt handler responsive to the interrupt for preempting the insecure operating system and tasks being subservient thereto, thereby preventing them from accessing the secured partition.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 schematically illustrates a system for securing data stored in a storage device, according to one embodiment of the invention;

FIG. 2 a flowchart illustrating the main operations performed by an access controller, according to one embodiment of the invention;

FIG. 3 is a flowchart illustrating operations performed by a secure operating system for securing data stored in a storage device, according to one embodiment of the invention;

FIG. 4 is a flowchart illustrating one embodiment for limiting memory access;

FIG. 5 is a flowchart, illustrating by way of example, operations performed by a secure controlling task in the embodiment of FIG. 1;

FIG. 6 is a flowchart illustrating by way of example operations performed by an access controller working in conjunction with the secure controlling task of FIG. 5;

FIG. 7 is a flowchart illustrating operator's manipulation on secured data, according to one embodiment of the invention;

FIG. 8 is a block diagram schematically illustrating a system for securing data stored in a storage device, according to another embodiment of the invention;

FIG. 9 is a flowchart illustrating in detail operations performed by the bus monitoring unit of FIG. 8, according to one embodiment of the invention;

FIG. 10 is a flowchart illustrating operations performed in a server upon receiving a request to open a secure communication line, according to one embodiment of the invention;

FIG. 11 is a flowchart illustrating the main operations performed in a secure controlling task of a server, according to one embodiment of the invention;

FIG. 12 is a flowchart illustrating operations performed by a secure interrupt handler in a server, according to one embodiment of the invention;

FIG. 13 is a flowchart illustrating operations performed by a secure interrupt handler in a server, according to another embodiment of the invention; and

FIG. 14 is a block diagram schematically illustrating a system for securing data stored in a storage device, according to yet another embodiment of the invention.

### DETAILED DESCRIPTION OF EXEMPLARY EMBODIMENTS

In the following description components that are common to more than one figure will be referenced by the same reference numerals.

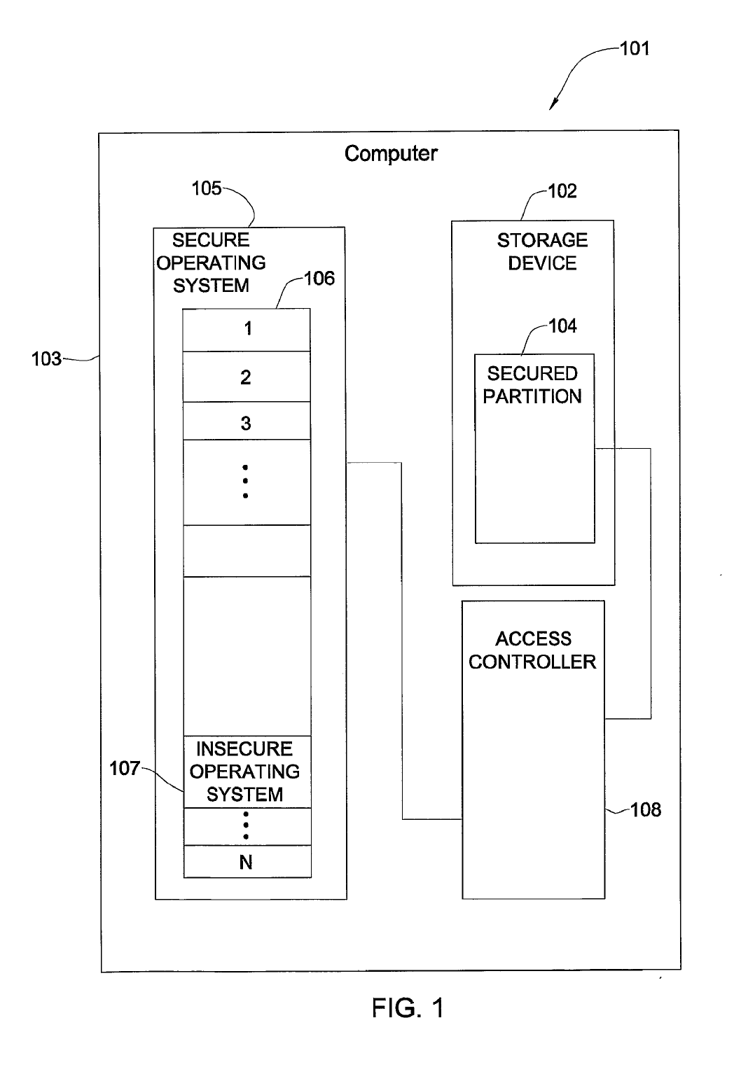

FIG. 1 schematically illustrates a system 101 for securing data stored in a storage device 102, according to one embodiment of the invention. The system 101 constitutes a “secured system” and a “sensitive environment”. The storage device 102 is coupled to a computer 103, such as a PC (Personal Computer) or a workstation. In the figure, the storage device 102 is internal to the computer 103, however, those versed in the art would appreciate that an external storage device can be coupled with the computer as well, wherein the external storage device can be directly or indirectly coupled to the computer.

The storage device 102 includes a discrete partition 104, constituting a “secured partition” or a “sterile partition”. It is noted, however, that this is non-limiting. For example, according to a different embodiment there may be several storage devices coupled to the computer 103 instead of one, while all or part of one storage available in the storage device can be used as a secured partition. Alternatively, there may be more than one secured partition. Partitioning a disk into two distinct partitions is known to those versed in the art, and is implemented, for example, in Voltaire 2in1PC.

The computer 103 has a secure operating system 105, constituting an “additional operating system” or a “sterile operating system”. The secure operating system 105 has access to data stored in the secured partition 104, constituting “secured data”. The secure operating system 105 has a set of secure tasks 106, including one or more predefined secure tasks, the set constituting a “tasks list”. Each task listed in the tasks list 106 constitutes a “secure task”. It is noted that a secure task operating in the secure operating system's environment has access to the secured data. Such a task is considered subservient to the secure operating system 105.

The tasks list 106 can include any number (N) of predefined tasks, one or more of the tasks being an insecure operating system 107. Microsoft-Windows, Linux, SunOs, Apple's Mac OS and others are examples of insecure operating systems. Normally, an insecure operating system has access to all data stored in the storage device, however, in accordance with the invention, the insecure operating system 107, constituting an “existing environment” (and subservient tasks thereof) can access only data stored outside the secured partition 104.

In addition, the computer 103 has an access controller 108, coupled with the storage device 102 and with the secure operating system 105. The access controller 108 is adapted to intercede access to the secured partition 104 and to induce operation of one or more secure tasks whenever access to the secured partition 104 is detected. Access signals to the secured partition (or more accurately, access signals to the disk controller, whose destination is in the secured partition) all pass through the access controller, which can buffer them, and decide whether to hand them over to the secured partition, or otherwise to block access thereto by depriving the partition from receiving the access signals. For example, if the storage device 102 is a SCSI disk, signals (or commands) are conveyed, or routed to the access controller 108, instead of being conveyed directly to the disk's respective SCSI controller. The access controller, in turn, conveys the commands further to the SCSI controller, or blocks them, thus blocking access.

Those versed in the art would appreciate that some of the components included in system 101 are included in computers existing today. The storage device is an example. However, some other components have been added to the system in order to provide security therefor, and hence they constitute “additional environment”. The access controller 108 and the secure operating system 105 are just two examples of such components.

It is noted that the term “access” is used to refer to read access (i.e., requesting to read data from the partition), write access (i.e., requesting to write data thereto) or any other attempt to access data, such as requesting to retrieve information relating to the partition's file system. Following this access, the disk controller tries to perform the required operation, and provides a “disk response”, e.g., the data read and/or an indication of the operation status. A “disk response interrupt” is indicative of the disk response. It should be further realized that there is a time period, constituting an “intermediate disk response period” between the access and the disk response.

Understanding this, it should be appreciated that data stored in the secured partition 104 is secured from potential damage caused, for example, by hostile software such as computer viruses and worms, which try to access and modify data stored therein. In addition, the data is secured from possible theft, performed, for example, by hostile software known as Trojan Horses. Thus, unless specifically noted, the term “damage”, when relating to secured data stored in the secured partition 104, is used hereinafter for referring to any kind of damage, including modification of data, data theft, etc. Therefore the secured partition 104 and the system 101 can be used for storing sensitive data.

It is further noted that if a virus, for example, penetrates the secured partition in any way (e.g., by copying a file contaminated with the virus into the secured partition), it can not damage the computer. The virus is not listed in the secure operating system's tasks list, and therefore the secure operating system will not activate and/or operate it.

According to one embodiment of the invention, the secure operating system 105 operates the insecure operating system 107 as a task thereof, wherein the insecure operating system's task has lower priority than any secure task listed in the tasks list 106. Therefore, if a task subservient to the insecure operating system 107 (an “insecure operating task”) tries to access the secured partition, the access controller 108 will detect the access and induce operation of a secure task subservient to the secure operating system 105 (an “induced task”). Because the induced task's priority is higher than the priority of the insecure operating system 107 operating the insecure operating task, the secure operating system 105 will preempt the insecure operating system 107 thus preventing it (and subservient tasks thereof) from accessing the secured partition 104. Those versed in the art will appreciate that when a process is preempted it loses control over the computer. The ability of one operating system to preempt another operating system is known in the art, and is implemented, for example, in products such as Wind River VxWorks, TenAsys iRMXforWindows and InTime.

It is noted though that whenever a secure task is loaded and/or initiated and/or activated, whether it is initiated further to receiving in interrupt, or by another task (secure or insecure), the insecure operating system is preempted if operative, as the secure task has a higher priority compared to the insecure operating system.

It is further noted that the access controller can induce operation of a secure task by directly operating it. Alternatively, it can indirectly affect operation thereof, e.g., by initiating an interrupt and conveying it to the secure operating system 105.

In embodiments where several secured partitions exist, it is possible to include one access controller unit for monitoring all the secured partitions together. Alternatively, it is possible to have several access controller units, each monitoring one secured partition. It is noted though that this is non-limiting and a combination can exist as well.

It is noted that according to one embodiment the secured partition is predefined, e.g. installed during the computer's manufacture. Alternatively, configuration software being part of the secure operating system can be used for defining the secured partition and its size. During operation it is possible to use such configuration software in order to re-configure the secured partition. In addition, it should be appreciated that according to embodiments of the invention executables of the secure operating system 105 and the tasks list 106 are stored in the secured partition 104 (or in one of the secured partitions, if there are several secured partitions in the system), securing them thereby. According to the embodiment, the tasks listed in the tasks list 106 are determined during installation or initial configuration of the system 101, and cannot be reconfigured later on, e.g., during run-time. That is, the tasks list 106 is considered rigid and pre-configured, and therefore hostile software cannot insert tasks thereto.

According to alternative embodiments, the tasks list 106 can be re-configured to list different tasks. According to the latter embodiment, list' reconfiguration is performed by a software, constituting a “tasks list configuration software”, which is listed as a secure task in the tasks list 106. The binary code of the tasks list configuration software is stored in the secured partition. In order to operate the tasks list configuration software and reconfigure the tasks list, an operator must be a privileged operator, such as a system administrator.

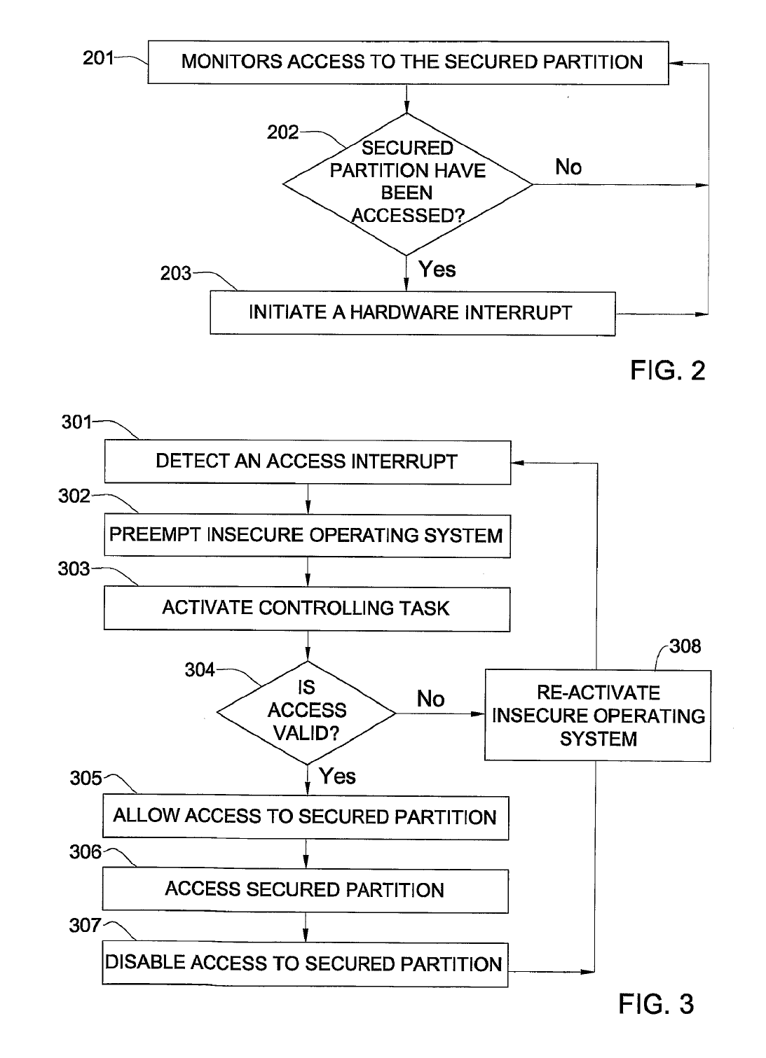

FIG. 2 is a flowchart illustrating the main operations performed by an access controller 108, according to one embodiment of the invention. In 201 the access controller monitors access to the secured partition 104. It does so, e.g., by interceding all access to the partition, in a way preventing undetected access thereto. When, in 202, the access controller detects that the secured partition has been accessed, it initiates, in 203, a hardware interrupt constituting “access interrupt”. It is noted that the access interrupt is conveyed to the secure operating system 105, inducing operation of a secure task and hence preventing further access to the secured data. It is noted that the flowchart of FIG. 2 is non-limiting and the access controller can perform alternative and/or additional operations such as checking whether the core processor operating in the computer 103 currently accesses or executes operations concerned with one or more predetermined addresses in memory.

FIG. 3 is a flowchart illustrating operations performed by a secure operating system for securing data stored in a storage device, according to one embodiment of the invention. The secure operating system 105 operates in kernel mode, therefore the core memory allocated therefor is inaccessible to other tasks operating in user mode, including hostile processes, which are prevented from interfering in the preemption procedure, or with secure tasks operating in kernel mode.

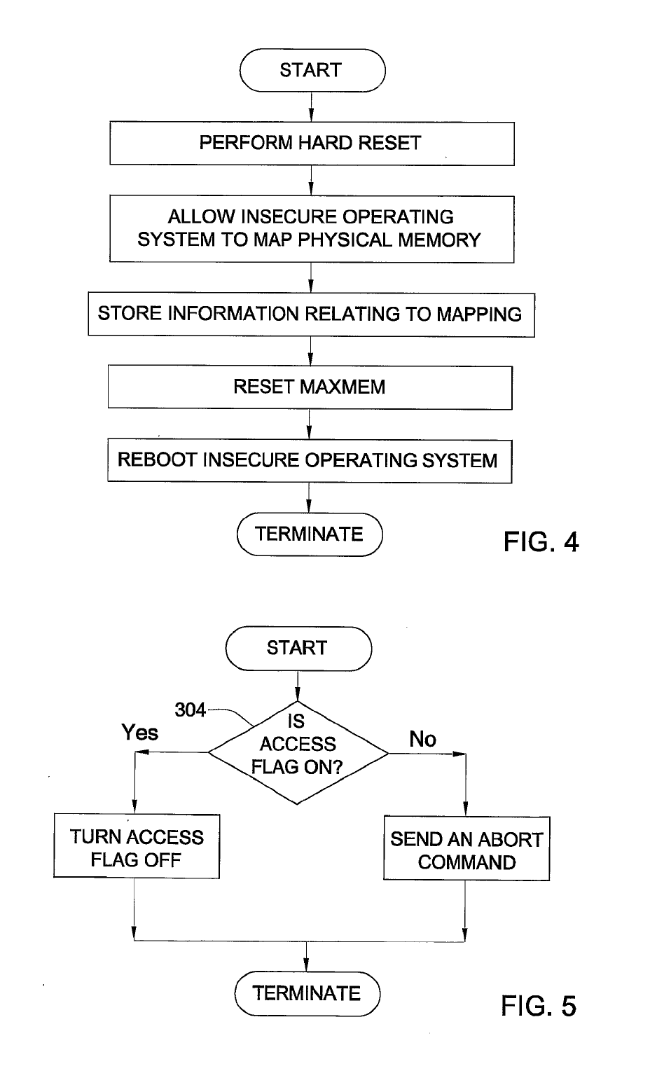

Before describing FIG. 3 in detail, it should be appreciated that according to one embodiment illustrated in FIG. 4, it is possible to allocate core memory to the secure operating system, wherein the allocated core memory is inaccessible to the insecure operating system and to its subservient tasks. According to the following example, wherein Microsoft Windows is the insecure operating system, this can be done by the aid of the MAXMEM parameter. When configuring the insecure operating system, hard reset should be performed, thus allowing the insecure operating system to start with the MAXMEM parameter unset. This allows the insecure operating system to map all the physical memory accessible thereto, generating mapping information. The mapping information, according to the embodiment, is stored in the storage device 102, in a location accessible to the secure operating system 105 and its subservient tasks, e.g., the secured partition. It is appreciated that the mapping information in this case will include the value of MAXMEM determined during startup, which is indicative of all physical memory accessible to the secure operating system. This value of MAXMEM constitutes an “inclusive-MAXMEM”.

Then, the MAXMEM parameter is set to a different value (constituting an “insecure-MAXMEM”), and the insecure operating system is restarted in a soft reset. Insecure-MAXMEM indicates the highest memory addresses accessible (or even familiar) to the insecure operating system, and hence the memory space starting at insecure-MAXMEM+1 can be used exclusively by the secure operating system. It is noted though that this is non-limiting and in systems where insecure-MAXMEM−1 represents has the highest memory addresses accessible to the insecure operating system, memory space starting at insecure-MAXMEM can be used exclusively by the secure operating system.

According to this embodiment the insecure operating system and its subservient tasks can gain access only to data stored in memory addresses within insecure-MAXMEM, while the secure operating system can access data stored within inclusive-MAXMEM. Understanding this it should be appreciated that the secure operating system can allocate memory space that is accessible both to itself and to the insecure operating system, hence it can allocate one or more sections of shared memory, sections that can be utilized, for example, for communications between the secure and insecure operating systems, and their subservient tasks.

In addition, understanding that the secure operating system and its subservient tasks operate in kernel mode, it is appreciated that they have control over the interrupt vector table (also referred to as the “interrupts pointers table” or “dispatch table”), that is, on the table where pointers to routines that handle interrupts are listed. Routines that handle interrupts are referred to as “interrupt handlers”. Hence, the secure operating system and its subservient tasks can force a secure interrupt handler to handle any of the interrupts, including access interrupts generated by the access controller 108, instead or in addition to the insecure operating system's insecure interrupt handler. In a similar manner the secure operating system can force secure interrupt handlers to handle the disk response interrupt and/or any other interrupt, such as keyboard interrupt.

Thus, returning to FIG. 3, when in 301 the secure operating system detects an access interrupt indicating access to the secured partition, the secure interrupt handler preempts the insecure operating system in 302, together with any operating task being a subservient thereof. It was previously noted that the insecure operating system has a lower priority than the secure operating system and any of the secure tasks, and therefore when the secure operating system receives the access interrupt it automatically preempts the insecure operating system, thus deactivating its operation and preventing further access to the secure operating system. In 303 the secure interrupt handler activates a secure controlling task that is listed in the tasks list 106. The secure controlling task constitutes a “loader” or a “buffer task”.

According to one embodiment the secure controlling task verifies that the access to the secured partition is valid (see 304), e.g., by requesting the operator to identify herself using a user name and password, and if so, in 305 access to the secured partition is allowed, thus allowing the secure operating system in 306 to access data stored in the secured partition 104. It is noted that according to one embodiment, the secure controlling task can send an abort command to the access controller in order to prevent unauthorized access, such as access performed by an insecure task. Furthermore, in 307 after the operator finishes the processing of secured data the access to the secured partition is disabled, and in 308 the insecure operating system is re-activated, thus allowing it to continue with its operation.

If in 305 the controlling task indicates that the detected access is invalid, the insecure operating system is re-activated in 308, without allowing access to the secured partition before. Therefore, the insecure operating system cannot access the secured partition, thus preventing damage to the data stored therein, while it is able to continue with any other operation not involving secure data access.

In order to allow access to the secured partition from a secure operating system and/or its subservient secure tasks, whenever the secure operating system detects an access interrupt, the access interrupt handler can, e.g., turn on an access flag (such as turning on a predetermined bit) readable by other secure tasks, including the secure controlling task, and inaccessible to insecure tasks. In turn, the secure controlling task, activated, for example, by the access interrupt handler, checks the status of the access flag and if turned off, it conveys an abort command to the access controller. On the other hand, if the access flag is turned on, the secure controlling task can turn it off, without sending any command to the access controller. The operations performed by the secure controlling task are illustrated, by way of example, in FIG. 5. It is noted though that the exemplary embodiment of FIG. 5 is non-limiting and other secure controlling tasks can operate in accordance with other embodiments, e.g., having opposite policies (when a turned off access flag indicates that access is requested by a secure task). Alternative secure controlling tasks can also convey a “proceed” command to the access controller, for indication that the access is secure, that is, that it is a secure task that tries to access the secure partition. Still another alternative is a controlling task that can request an operator to authorize access (e.g., by identifying and inserting a password, or by reviewing modifications) before switching the access flag.

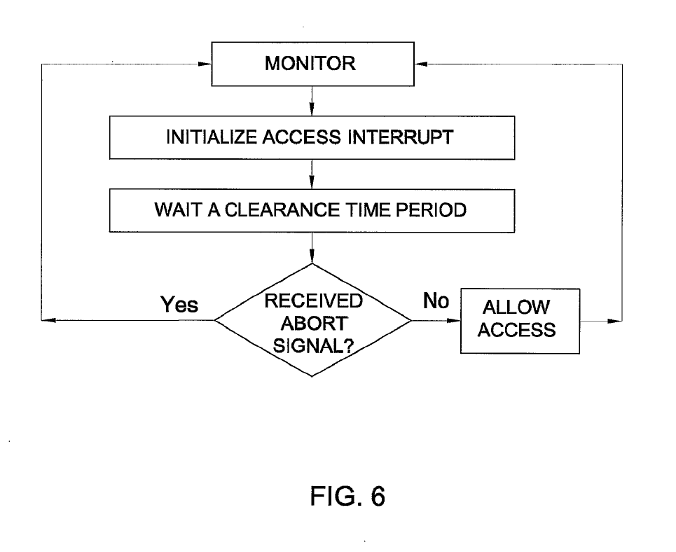

In turn, an access controller operating in a system 101, where the secure controlling task operates in accordance with the embodiment of FIG. 5, waits a certain amount of time, constituting a “clearance time period”, further to initiating an access interrupt. If the access controller receives an abort command during this clearance time period it does not allow the access, as it appears to be from an insecure task. On the other hand, if the clearance time period lapses without receiving any command, the access controller deduces that the access is performed by a secure task, hence allowing it. The operations performed by the access controller are illustrated, by way of example, in FIG. 6. Yet, alternative embodiments are allowed for the access controller as well. One such alternative embodiment is an access controller waiting for a proceed command for allowing access, in addition to or instead of allowing the clearance time period to lapse.

It is appreciated that many times access commands appear in succession and hence they constitute together a “succession of access commands” or shortly, a “succession”. A very simplified example is reading data from a large file. It is appreciated that in this case it may become impossible to read the whole data included in the file within one access, and therefore several read-access commands are required, each reading a successive portion of the file, until all data included in the file are read. The access-command that starts the succession constitutes an “opening access command” and it is indicative of an “opening access”. The last successive command of each succession constitutes a “terminating access command” and is indicative of a “terminating access”.

It is noted though that a succession of access commands can be (and many times it is indeed) much more complicated than the latter example. For example, a succession does not necessarily refer to data included in one file, or it is not limited to read-access commands (neither to any other single type of commands). Yet, it is appreciated that according to the invention, in every succession trying to access the secured partition, the opening access command is issued by the insecure operating system or by one of its subservient tasks. Hence the access controller, detecting that opening access, blocks its progression and issues an access interrupt. In addition, a terminating access command, according to the invention, is a command received from the secure operating system (or from one of its subservient secure tasks) informing the access controller that operation of the insecure operating system has been resumed.

Furthermore, the access controller can relay to the disk controller those access commands that follow the opening access command in a succession (constituting “successive access commands”), thus allowing them to access secured data. Therefore, when operating in accordance with the embodiment of FIG. 6, relaying the opening access command and successive access commands will be allowed only upon the lapse of the clearance time period (or after receiving a proceed command, in accordance with an alternative embodiment). Alternatively, upon receiving an abort command, the access controller will block successive commands. Consequently, only successions approved by an operator, for example, will be relayed and hence allowed by the access controller. It is noted, however that according to the described embodiment terminating access commands are not relayed to the disk controller, as they are used for internal communication between the secure operating system and the access controller.

In order to verify that a terminating access command is issued by a secure task, the access controller can issue an access interrupt upon receipt thereof, and wait a clearance time period before terminating the succession. If additional access commands are received before the clearance time period lapses, the access controller will buffer them, until it can determine whether they belong to the previous succession or whether they start a new succession.

It was previously noted, an intermediate disk response period starts following an allowed access to the secured partition. Thus, during the intermediate disk response period, according to several embodiments of the invention, operation of the insecure operating system and its subservient tasks is restored (i.e., control is relinquished back to the insecure environment), while the access controller buffers access attempts performed thereby, as long as these access attempts are to data stored outside of the secured partition. When the disk response interrupt is initiated, the respective secure interrupt handler is activated, preempting the insecure operating system thereby.

Turning now to the secure operating system, during access to the secured partition 306, it sometimes operates an “interfacing task” wherein the interfacing task allows a third party, e.g., a human operator, to provide instructions and indications as to required operations. It should be appreciated that in some embodiments the interfacing task is joined with the controlling task, while in other embodiments these are two separate tasks, but one way or the other the interfacing task is a secure task.

For example, when the operator wants to secure data included in previously unsecured files, it is possible mark the relevant file names and then activate an interfacing task for moving the marked files from their previous position in the storage device to the secured partition.

In order to verify that the moved files are indeed those files selected and marked by the operator, a validation procedure is required. For example, the operator will be requested to verify the file's content, e.g., by displaying the file's respective data to the operator prior to writing it into the secured partition, thus allowing her to check data integrity, in order to approve or disapprove that the data is not corrupted. If the data is corrupted or when the operator suspects that hostile software (or code) interfered with the data, she is allowed to disapprove the data integrity, and the interfacing task will not allow writing of the data into the secured partition. Alternatively, or additionally, the operator can be asked to type her password as part of the validation procedure, scan her fingerprints, or any other operation applicable for validation.

In order to process secure data while using insecure tools, such as a word processor, the operator can select a file (as commonly performed in nowadays existing systems) to be copied into a storage area which is outside the secured partition. Before the file is copied the interfacing task has to validate the identity of the operator, thus preventing data theft. Hence she is asked to type a password.

Similarly, when she terminates editing and wishes to store the content back into the secured partition, the interfacing task requests her to verify the data again, with or without requiring a password, and then copies the data into the secured partition.

Remembering that the interfacing task is a secure task, one would appreciate that upon activation thereof the insecure operating system is preempted, and therefore access to the secured partition is allowed.

Yet, the example above is non-limiting and alternative embodiments of the interfacing task can exist. One such alternative embodiment can verify data by displaying only modifications inserted to the data since its extraction from the secured partition, unlike displaying the entire amount of data, as described with reference to the previous example. Another alternative can allow the operator to store an unsecured copy of the data. In addition, in another non-limiting alternative, the operator can be allowed to keep previous versions of the data apart from storing the new version thereof. It should be appreciated that this latter embodiment can use, for example, a known per se version control tool, such as Rational ClearCase by IBM and other tools, in order to manage versions in the secured partition.

It should be appreciated that when the third party is a human operator, the interfacing task communicates with her via a user interface, such as a graphical user interface item (e.g., a menu including menu items and/or a window including text and data fields etc.) or a textual user interface. The user interface can be displayed as a full-screen display or it can be displayed on a portion of the screen. When operator interaction is not required the user interface can be turned off. Alternatively, if the user interface is displayed on a portion of the screen it is sometimes possible to have a windows-type interface, wherein the window can be minimized or maximized, brought to the display's front etc., including any operation allowed on windows. Yet, the user interface can occupy a constant section on the screen, where it can be constantly displayed etc.

To this end it should be realized that by leaving copies of the secured data stored outside the secured partition, risk of data theft arises. In addition, when the operator verifies the data certain modifications inserted thereto can be missed, especially if those are hidden in the file. For example, it is possible to attach executable instructions to a file including data processed by a word processor, while the instructions are not visible when displaying the file's content. Yet, the instructions in this example cannot execute while in the secured partition, as they are not listed in the tasks list, and hence no further damage can be affected thereby to secured data.

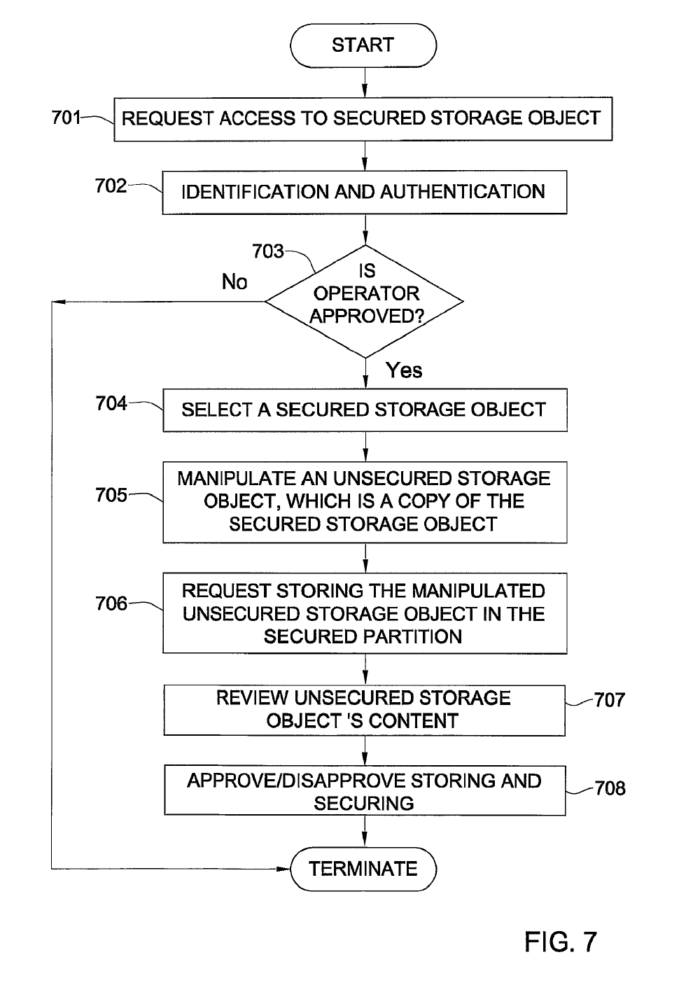

FIG. 7 is a flowchart illustrating an operator's manipulation of secured data, according to one embodiment of the invention. In 701 the operator requests access to secured data stored in a secured partition. The secured data can be any data stored in the secured partition, such as data stored in a file or in a database. Hereinafter, a file, database table, etc. used for storing data is generally referred to as a “storage object”, wherein a storage object can be a “secured storage object” or an “unsecured storage object”. In 702 the operator identifies herself, e.g., by typing her user name and password, by scanning a key such as a magnetic key, or by any other identification and authentication method applicable to the case. If the operation is approved by the system (see 703), in 704 she is allowed to select a secured storage object she wants to manipulate. The selected secured storage object is copied into an unsecured partition, thus generating an unsecured storage object, and in 705 the operator can manipulate the copy of the file freely, using any tool available and applicable to her requirements. It was previously noted, with reference to FIG. 3, that the secure operating system has control over the interrupt vector table. Therefore, it is noted that in order to allow the insecure operating system and its subservient tasks to operate, the secure operating system can restore the interrupt vector table if required, returning the insecure interrupt handlers thereto.

When the operation is done, she can store the manipulated storage object into the secured partition. In order to do so in 706 the operator requests storing the file, in 707 she reviews the content of the file in order to detect hostile modifications, and in 708 she approves or disapproves storing and securing the file in the secured partition. When storing the storage object the access controller detects access to the secured partition, thus initiating the access interrupt, returning control to the secure operating system thereby.

It is noted that according to the illustrated embodiment, if the operator wants to further edit data in the secured storage object, she has to request access thereto again. However, this is not-limiting and according to different embodiments she can be given the option (e.g., in 706) to store the data in the secured partition and continue working thereon. For example, this is possible by storing a copy of the data in the secured partition, while leaving the copy of the unsecured stored object for the operator to continue editing.

Other alternatives of the FIG. 7 embodiment may exist as well. For example, instead of requesting identification and/or authentication in 702, the secure operating system can receive access confirmation from another process or computer (e.g., from a server sending a one time encrypted message using keys stored in the secured partition), then it can issue a message indicating that access to the secured partition has occurred. In addition, according to embodiments alternative to FIG. 7 the operator can indicate whether or not she wants to review the data before storing (see 707).

One time encryption is performed, according to one embodiment, using an initial encryption key and a key generator for generating a new key, constituting a “one time key”, based on the initial key. One time key generation should have a deterministic generation scheme, such as generating the one time key based on the initial key, the identity of a designated entity and date, or any alternative deterministic scheme.

Understanding this, it should be realized that if two or more entities exchange encrypted data, they can exchange the initial keys, each one of the entities storing other entities' keys in its secured partition. Then, if each of the entities has an instance of the key generator, all instances share the same deterministic generation scheme and use exchanged initial keys, it is appreciated that the exchanging entities will be able to decrypt data encrypted by any one of the other entities using one time keys.

Yet, it is appreciated that hostile software can pretend to be a secure task. For example, one such hostile software can display to the operator a user interface that is hard to differentiate from a secure task's interface. The operator might think the fake interface to be a secure task's interface (see, for example, 701 and 706 in FIG. 7), and perform actions that will eventually allow the hostile software to access secure data, e.g., by faking the storing of data in the secure partition.

One way to prevent hostile software from intervening and/or modifying displayed user interface is for the secure operating system to write data directly into the computer's frame buffer, which is a buffer in core memory, storing information to be displayed on a screen, without using an insecure task for the display.

Alternatively, the initial loading of the secure operating system is required for preventing the insecure operating system from inhibiting the loading of the secure operating system, whereupon pretending hostile software can, e.g., persuade the operator to allow access to the secure partition. However, upon computer startup it is sometimes the insecure operating system that loads into memory first, followed by the secure operating system. In such a computer, there is a high risk that hostile software will take advantage of the situation.

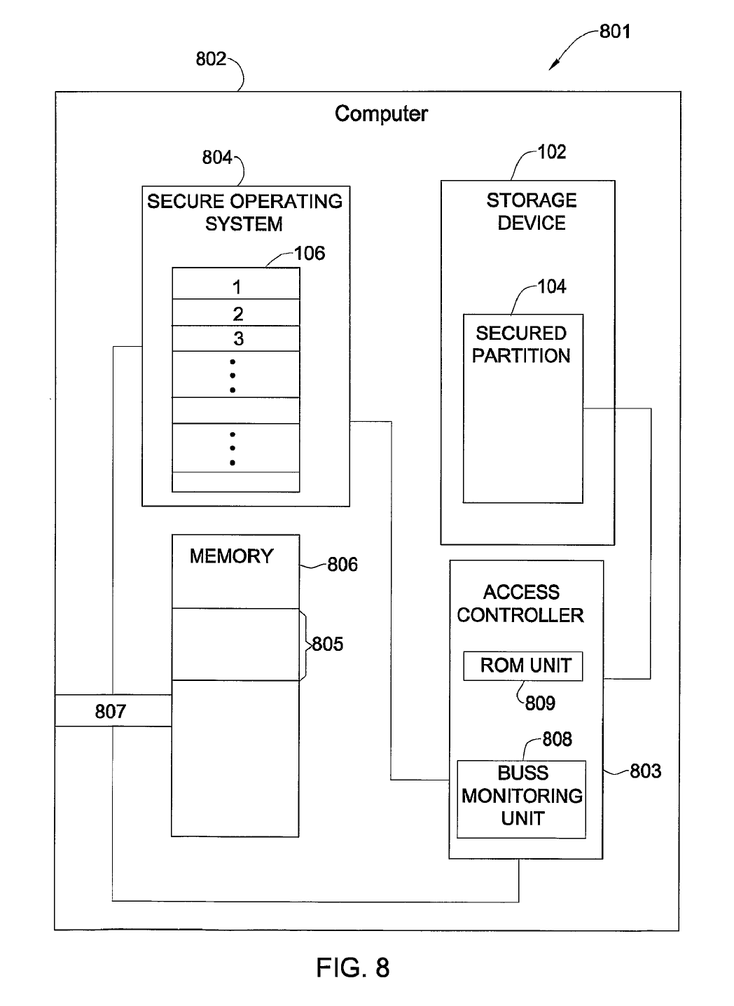

Yet, it is possible to overcome the later risk by using another embodiment of the invention, whose block diagram is illustrated in FIG. 8. The system 801 of FIG. 8 includes a computer 802, and a storage device 102 that includes one or more secured partitions 104, like the system 101 of FIG. 1. In addition, system 801 includes an access controller 803, which is coupled to the secured partition 104 and to a secure operating system 804, wherein the secure operating system 804 includes a tasks list 106. However, unlike system 101, in system 801 the secure operating system has a section 805 in memory 806, dedicated for the secured operating system. The section 805 resides in a predetermined, unchanging memory address space, and therefore it constitutes a “predetermined memory section”. The secure controlling task, when initiated, is loaded into a predetermined address in the predetermined memory section 805. According to the embodiment, addresses in the predetermined memory section are accessed by their absolute addresses, in contrast to relative addresses. In addition, these are only the secure operating system 804 and its subservient tasks which are allowed to access the predetermined memory section 805.

Furthermore, as illustrated in FIG. 8, the access controller 803 is coupled to the computer's data bus and address bus (marked together as 807), thus allowing it to detect operations performed in the predetermined memory section, including loading of tasks thereto. The module in the access controller that monitors the busses and detects operations performed in the predetermined memory section is referred to as a “bus monitoring unit” 808. To this end, the access controller 803 of the current embodiment is coupled with a Read Only Memory (ROM) unit 809 where it is possible to store objects such as an object storing a copy of the secure controlling task's binary code. The access controller can, therefore, compare an object loaded into a predetermined address in the predetermined memory section 805, with an object stored in the ROM unit 809. According to the latter example, where a copy of the secure controlling task's code is stored in ROM unit 809, and knowing the predetermined address in the predetermined memory section where the secure controlling task should be loaded to, the access controller 803 can compare the object loaded into the predetermined address with the copy stored in ROM unit, wherein identity confirms that the loaded object is indeed the object storing the code of the secure controlling task. Nevertheless, according to alternative embodiments, it is unnecessary to store a copy of the complete object in ROM, and copies of one or more sections, constituting “key sections” can be stored instead. For example, one alternative embodiment can store copy of an initial section, while comparing this copy with the object loaded to the respective predetermined address can reveal whether the identity of the loaded object is as expected. Another alternative can store a copy of the object tail, any other section, or even a plurality of sections.

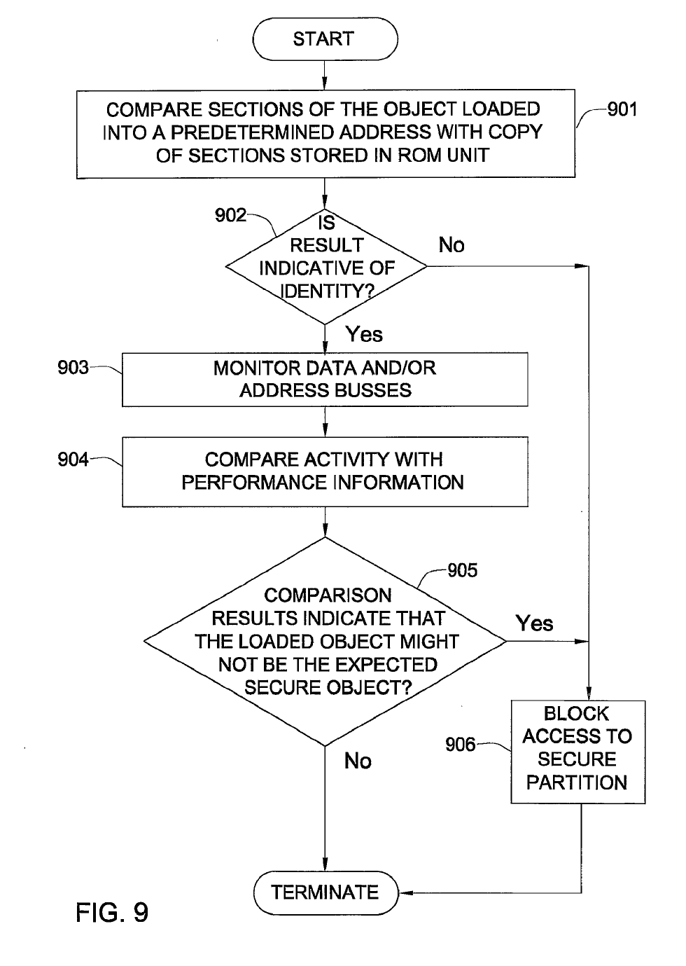

The embodiment of FIG. 8 is sometimes referred to as an “internal hardware embodiment”, operating in accordance with an “internal hardware approach” described in detail with reference to FIG. 9 below. On the other hand, the embodiment of FIG. 1 is sometimes referred to as an “external hardware embodiment” operating in accordance with an “external hardware approach”.

It is noted that according to the embodiment of FIG. 8, the storage device 102 is internal to the computer 802, however, those versed in the art would appreciate that an external storage device can be coupled with the computer as well, wherein the external storage device can be directly or indirectly coupled to the computer. In addition, similar to the embodiment of FIG. 1, in FIG. 8 there can also be more than one secure partition.

Upon starting the secure operating system, it loads the secure controlling task into a predetermined address in the predetermined memory section 805. Knowing the predetermined address where a secure controlling task should be loaded, the access controller can monitor the computer's busses 807, and identify that it is a secure controlling task indeed that is loaded to the respective predetermined address, or otherwise it can prevent access to the secured partition 104, as the access controller interleaves access thereto. In addition, according to the current embodiment the secure controlling task acts as a loader, thus loading other secure tasks required for processing secured data. It can thus be appreciated that binary code operated in processing of the secured data is loaded, or activated by the secure operating system, and hence it is secure.

The operation of the bus monitoring unit is now described in detail with reference to flowchart of FIG. 9. After comparing (in 901) sections of the object loaded into one or more predetermined addresses with copies of sections stored in the ROM unit 809, if the comparison result is indicative of identity (902), the bus monitoring unit still has to verify that the complete object loaded into the predetermined memory section 805 is a secure object of a secure task.

In order to do so, according to the embodiment, the bus monitoring unit, which is familiar with the secure task and its respective object, can identify operations performed by the task, e.g., based on timing signals, operations performed and addresses accessed thereby. Information relating to operations that a task is expected to perform is referred to as “performance information”, and it is appreciated that the bus monitoring unit can have performance information accessible thereto, e.g., if such information is stored in the secure partition. Hence in 903 the bus monitoring unit can monitor the data and/or address busses and compare the loaded object's activity with performance information accessible thereto (in 904). If in 905 the 904's comparison results indicate that the loaded object might not be the expected secure object, in 906 the bus monitoring unit blocks access to the secure partition (or instructs/allows the access controller to do so), thus preventing the loaded object and the respective task from accessing secured data stored therein.

It should be appreciated that according to the embodiment illustrated in FIG. 9, if an insecure interrupt handler is initiated further to an access interrupt raised by the access controller (e.g., an interrupt handler introduced by a hostile software that inhibits the secure operating system), the access controller, or the bus monitoring unit operating on its behalf, which has performance information relating to the secure interrupt handler accessible thereto, will identify that the loaded interrupt handler is not the secure interrupt handler, and block access to the secure partition. In a similar way, they can verify the identity of the secure controlling task, or any other predetermined secure task.

Yet, the embodiment of FIG. 9 is non-limiting and another exemplary embodiment can, for example, produce a proceed command further to determining in 905 that the loaded is the expected secure object.

It was previously noted, with reference to FIG. 5, that the insecure operating system's operation is sometimes restored during the intermediate disk response period, while the access controller buffers access attempts performed thereby, as long as these access attempts are to data stored outside of the secured partition. When the disk response interrupt is initiated, the respective secure interrupt handler is activated, preempting the insecure operating system thereby. It should be appreciated that such embodiments are applicable also with reference to FIG. 9.

Understanding the embodiments of FIGS. 1 and 5, and several alternatives thereof, it is appreciated that all the embodiments described above provide security to data stored in a standalone computer. However, security is required also in a networked environment, e.g., when a first computer, constituting a “client”, accesses secured data stored in a secured partition of a second computer, constituting a “server”.

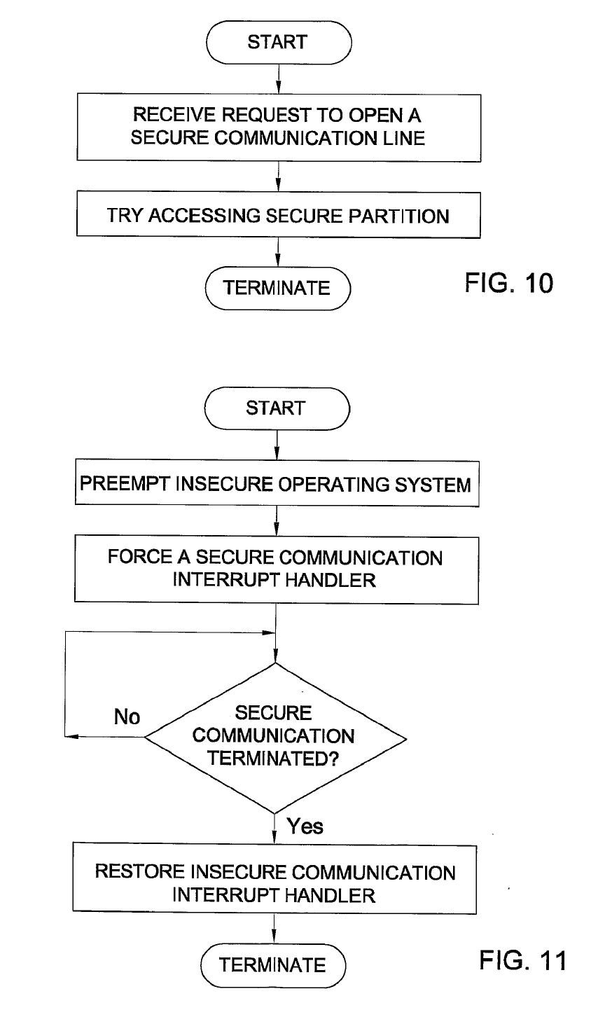

In order to be able to control secure communication between the client and the server, each one of the client's and server's secure operating systems can force a secure interrupt handler for communication hardware interrupts, whether they are issued by a modem (modulator-demodulator known per se) or by any kind of NIC (Network Access Card). The forced interrupt handler constitutes a “secure communication interrupt handler”, while the interrupt handler used by the insecure operating system as communication hardware interrupt handler constitutes an “insecure communication interrupt handler”. Hence, when a server receives a client's request to open a secure communication line, that is, a communication line for transferring secured data, the servers' insecure communication interrupt handler tries to access the secured partition. This in turn activates the access interrupt and the secure operating system's secure controlling task, as illustrated in the flowchart of FIG. 10. The secure controlling task preempts the insecure operating system, forces a secure communication interrupt handler to handle forthcoming secure communication, wherein the insecure communication interrupt handler will be restored upon termination of the secure communication. The main operations of the secure controlling task are summarized in the flowchart of FIG. 11. It is noted that according to the embodiment illustrated in FIGS. 10 and 11, the client has to request opening a new secure communication line. However, this is non-limiting and the client can use a previously opened communication line for transferring secure data. In this case, the first packet carrying secure data would trigger access to the secured partition, and hence the embodiments of FIGS. 10 and 11 can apply. When the server sends secure data to a client, the client operates in accordance with FIGS. 10 and 11 as well.

At the same time, it should be appreciated that it is a secure task operating from the client, who sends secure data (including a request to open a secure communication line) via communication lines, e.g. to a server. This implies that when the client's respective communication hardware issues a communication hardware interrupt, this interrupt activates the secure communication interrupt handler. Similarly, the server's secure communication interrupt handler is activated when the server sends secure data via communication lines, e.g. to a client.

In order to secure data transmitted over the communication lines from the client to the server and vice versa, it is appreciated that data can be encrypted. Understanding that data can be protected in the client's and server's secure partitions (e.g., in accordance with the embodiments described with reference to FIGS. 1 and 5), it can be realized that the encryption keys and an object storing the binary code of the encryption task used for the encryption of transmitted data can be stored as secured data in the respective secured partitions. It is possible to further increase security by using one-time keys; one embodiment for generation thereof is described above.

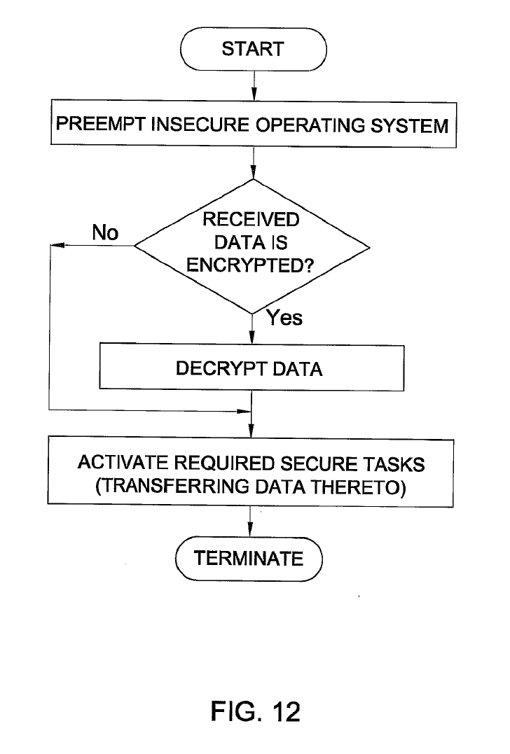

Thus, it should be appreciated that upon receipt of further packets from the communication hardware, the secure communication interrupt handler is activated, operating, e.g., in accordance with the flowchart of FIG. 12. After preempting the insecure operating system the secure communication interrupt handler checks whether the communicated data is encrypted, and if so it decrypts the data. Then it activates one or more secured tasks required to handle the data, that is, the decrypted data is transferred to the activated secure tasks, as required.

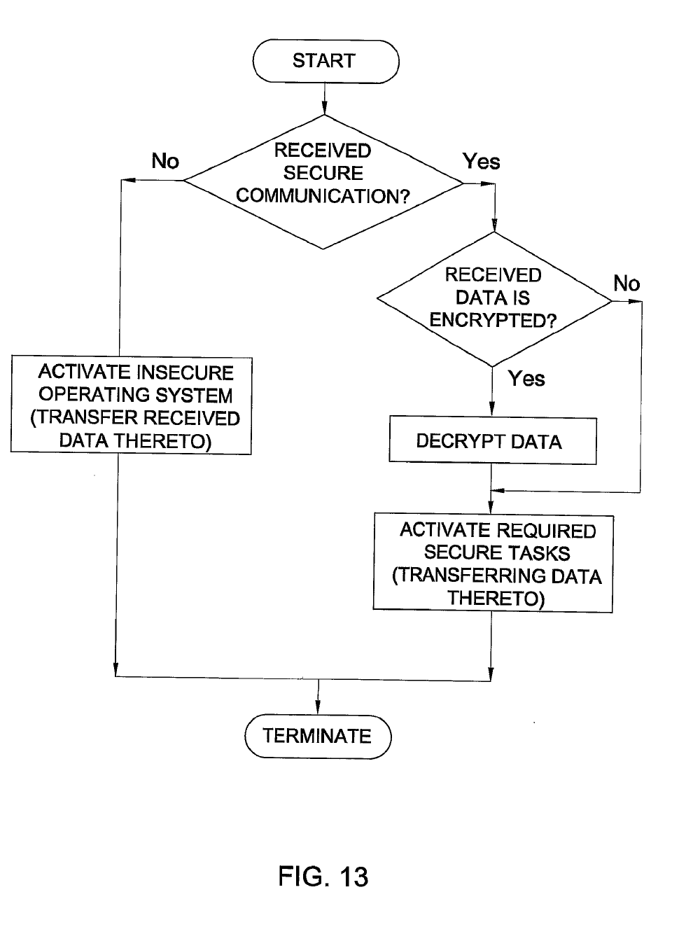

It was explained before, with reference to FIG. 11, that upon receipt of a secure communication request a secure communication interrupt handler is forced, wherein the insecure communication interrupt handler is restored upon termination of the secure communication. However, this is non-limiting and alternative embodiments may exist where the secure communication interrupt handler is permanently set as the computer's communication interrupt handler. Such an embodiment operates in a reverse approach to this illustrated in FIG. 12, wherein it is appreciated that it is always the secure communication interrupt handler that is activated upon any receipt of information from the communication network, whether secure or insecure. Thus, if the packet is identified as including insecure data, the insecure operating system is activated and given the data for further processing. However, if the data turns out to be secure data, it is unnecessary to preempt the insecure operating system, and the required secure task can be directly activated (with or without decrypting the data, as required), as illustrated in FIG. 13. It is further possible to delete the insecure communication interrupt handler's object, thus assuring that it cannot be activated, e.g., by hostile software. It should be appreciated that having a permanent secure communication interrupt handler also affects the robustness of the system against DoS and DDoS attacks. Policies that can be introduced into the secure communication interrupt handler's activity can identify such attacks (e.g., by identifying that a certain number of packets, all having resembling content and all are sent from a single address) and block the packets from loading the processor.

It was also explained above that there might be an interfacing task that is designed to display user interface items to the operator, e.g., for requesting her confirmation to secure operations and data. However, it should be realized that a server is not necessarily coupled with either a screen or a keyboard, and most of the time there is no operator controlling or monitoring its activity. Therefore an alternative embodiment is suggested, wherein operator confirmation is received via the communication lines before data is stored in the secured partition of the server. According to one embodiment the server transmits (using secure communication) to the client, data to be displayed in the client's interfacing task, wherein the client can send to the server the operator's responses (again, using secure communication). Alternatively, the client's operator confirms sending requests to the server, wherein this confirmation can be regarded also as a confirmation for storing the data. It is further possible to transmit the operator's password together with the request, or separately therefrom. In this latter example the password can be encrypted to increase security, using stored encryption keys or even one-time generated keys.

According to one embodiment of the invention, it is possible to store encryption/decryptions keys in the secured partition of a client computer. If storing is performed while avoiding the usage of communication lines (e.g., by coupling the client computer directly to the server, or by copying the keys directly from a detachable storage device such as a disk-on-key) it can be considered secured and hence the keys are considered secured as well. If the keys are known by the server to be uniquely corresponding to the operator, then any communicated message encrypted with one or more of the keys can be regarded as communication authenticated by the user, this without the operator typing her password.

Furthermore, unlike the standalone embodiments, where operation of the insecure operating system and its subservient tasks are restored during the intermediate disk response period, in several embodiments operating in a networked environment control is kept at the secure environment (i.e., operation of the client's and server's insecure operating systems is not restored during the intermediate disk response period).

It was noted before that hostile software might be able to inhibit the secure operating system thus preventing its operation, and a solution was suggested that solves the problem (see FIG. 8, for example). It should be appreciated that in this case, when the hostile software inhibits the secure operating system, data stored in the secured partition might become inaccessible. In order to overcome this limitation, it is possible to force generation of an access interrupt, or any other interrupt triggering a secure interrupt handler, e.g., by pressing a button coupled with the computer. Hence, the secure operating system will gain control of the system without allowing access to any hostile data.

In a networked environment, if the secure communication hardware interrupt handler is left as a permanent communication interrupt handler, sending any message to the server will activate the secure communication hardware interrupt, and hence the secure operating system, allowing it to control the system.

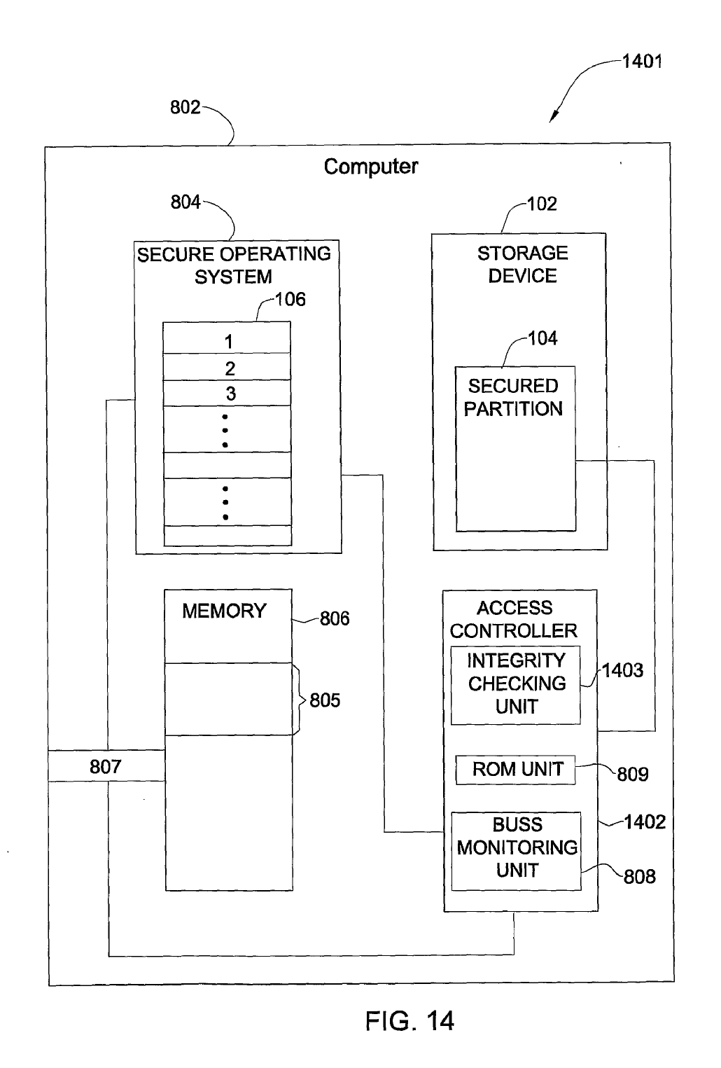

Another embodiment can periodically check the integrity (or sanity) of the system. A security system, such as system 1401 is depicted in FIG. 14, whereby the integrity of the system can be checked. It is appreciated that basically the system 1401 resembles system 801 of FIG. 8, apart from the access controller 1402, which is different. Like the access controller 803, the access controller 1402 includes a ROM unit and a bus monitoring unit, which can be similar to or different from the bus monitoring unit 808 and/or the ROM unit 809 of the access controller 803. Therefore, it should be appreciated that although the bus monitoring unit 808 and/or the ROM unit 809 are depicted in FIG. 14, this is non-limiting and any other bus monitoring unit and/or the ROM unit can be used.

In addition, the access controller 1402 includes an integrity checking unit 1403 that can check the system's integrity, thus verifying that the secure operating system is not inhibited, e.g., by hostile software. According to one embodiment the integrity checking unit 1403 can activate an insecure task constituting an “integrity checking task” whose pattern of activation is inaccessible from the insecure operating system. For example, the integrity checking task can start operating once in a predetermined time period determined during its installation, wherein the predetermined time period is secured information known only to the integrity checking unit (which is considered as part of the secure environment).

Alternatively, the integrity checking task can start operating once in a changing time period, dictated by the integrity checking unit, e.g., by issuing a hardware interrupt constituting an “integrity interrupt”. In turn, the integrity interrupt activates a secure interrupt handler for performing the integrity test (hereinafter a “secure integrity testing interrupt handler”), wherein the secure integrity testing interrupt handler can be the integrity checking task or it can cause the activation thereof. The integrity checking unit 1403 can issue the integrity interrupt periodically, once in a predetermined or randomly determined time interval, and/or it can issue it in response to input provided by the operator, e.g., by pressing a button. Yet another embodiment can be using memory shared between the secure and insecure operating system for controlling the integrity checking task's activity, wherein the possibility of having shared memory was mentioned before, e.g., with reference to FIG. 4. Shared memory can be used also for transmitting messages from the integrity checking task to the access controller in general, or more specifically, to the integrity checking unit. Messages can include, for examples, indications for things that the integrity checking task requires the integrity checking unit to test, such as access to certain addresses in the storage device. Since the integrity checking task's pattern of activation is unknown to insecure tasks, including hostile software, the messages cannot be understood by such insecure software. In addition is it appreciated that hostile software cannot generate such messages.

The integrity check task should issue indications, while it is running, that the integrity check unit can check. Since the pattern of activation of the integrity check unit is known only to the integrity check unit, hostile software cannot generate such indications.

Furthermore, it should be appreciated that an integrity checking unit, such as integrity checking unit 1403 is not exclusively designed for the access controller 803 or 1402. For example, such an integrity checking unit can be combined also with the access controller 108 of FIG. 1.

It is noted that according to certain embodiments, if the integrity checking unit 1403 cannot determine (e.g., by the aid of the secure integrity testing interrupt handler) that the secure operating system has full control over the system, it can issue a reset interrupt, rebooting the computer thereby. However, this might require hardware modifications, e.g., in the computer's motherboard, like adding a known per se OR logical gate for allowing to reset the CPU, thus allowing issuance of a reset interrupt from the access controller, apart from other, currently existing sources, such as a reset button that can exist in the computer. The existence of a specially designed button is not required, and those versed in the art would appreciate that an existing button (such as Alt, Ctrl etc.) can be assigned for the purpose of resetting, or even a combination of buttons (such as the combination of Alt+Ctrl+Del, which is commonly used today). An alternative, or additional hardware modification is adding a known per se jumper to the motherboard, via which the reset interrupt can be conveyed to the logical OR gate, a jumper originating, for example, in the access disk controller board.

It should be appreciated that the integrity testing, when combined with resetting the system, can be used for coping with DoS and DDoS attacks. In case of such an attack the integrity testing will reveal that the secure operating system does not have full control over the computer's CPU, thus resetting the computer and allowing recovery thereof.

Furthermore, according to yet another embodiment it is possible to load and activate the secure operating system while booting the computer, inhibiting the insecure operating system from operating for a certain period of time, constituting “secure operating system exclusivity period”. It is noted that the secure operating system exclusivity period can be a predetermined period, configured, for example, when manufacturing, installing or configuring the secured system. Alternatively, it is possible to determine the secure operating system exclusivity period based on statistical calculations, e.g., the average time since the booting of the system and until the integrity checking unit 1403 cannot detect that the secure operating system does not have full control over the system.

The embodiments and examples presented above, all relate to real-time processing, wherein the secure operating system is activated substantially immediately after each operation relating to secured data is started, or more accurately, following every request to a secure service (whether it is an access request for secure data, a request for secure communication etc.). However, bearing in mind that for each activation of the secure operating system the insecure operating system has to be preempted, secure tasks have to be activated etc., it is appreciated that each such secure operating system activation is time consuming and thus degrades the performance. This is specifically important, normally, in a server. Hence, according to an alternative embodiment, it is possible to perform batch processing of more than one secure request. That is, secure requests can be accumulated, e.g., in a buffer, and then processed together, e.g., during one activation of the secure operating system.

It is noted that some of the embodiments presented above can be applicable, e.g., in e-commerce applications where information relating to customers is stored, including, for example, customers credit card numbers and identification information. Banks and other financial institutions can also be subject to deployment of the invention and any other institution that needs to secure data stored in its storage devices, including even technology-developing companies, who need to protect their knowledge base from industrial espionage. Another possible application is in servers allowing remote control thereof. Such servers can store binary objects of the software allowing such remote control and other sensitive procedures in the secured partition, thus preventing activation thereof by insecure tasks, including hostile software operating in remote computers. It is appreciated that the communication between secure remote controlling computers and remote controlled servers can be encrypted; hence it can utilize the Internet instead of requiring that private networks be applied.

Also, remote servers can be designed such that they gather periodically physical data from various measurement facilities connected to them, and these measurements can trigger proper interrupts of their secured environments. In such a scheme, the servers can make decisions, under the protection of their secured environment, based on the measured data. This leads to secure automatic operation of the servers. Hostile software will not be able to intervene in this process, since it cannot mimic the required hardware interrupts.

1-39. (canceled)

40. A method for securing data stored in a secured partition of a storage device from access by an unauthorized third party such as an unauthorized human operator or an unauthorized remote computer, said storage device is coupled to a computer having an insecure operating system that is subservient to a secure operating system operating on the computer, said secure operating system is adapted to operate only secure tasks which are members of a predefined set of secure tasks, comprising at least one secure task for providing security against hostile software, the method comprising:
detecting access to the secured partition;
interrupting the secure operating system;
responsive to said interrupting, preempting the insecure operating system and tasks being subservient thereto, thereby preventing them from accessing the secured partition; and
activating a secure task, after the preemption of the insecure operating system, for determining if the third party is an authorized third party.

41. The method according to claim 40, wherein the set of secure tasks may contain a configuration task for reconfiguration of the set of secure tasks by a privileged operator such as a system administrator.

42. The method according to claim 40, wherein the insecure operating system has a lower priority than any one of the secure tasks in said predefined set.

43. The method according to claim 40, wherein the secure operating system is adapted to allow access to the secured partition in accordance with input provided by a third party.

44. The method according to claim 43, wherein the third party is a human operator.

45. The method according to claim 44, including interacting with the secured operating system via a user interface.

46. The method according to claim 43, wherein the third party is a secure task adapted to operate in the computer.

47. The method according to claim 43, wherein the third party is a second computer.

48. The method according to claim 47, wherein the second computer is adapted to operate a secure operating system.

49. The method according to claim 47, including exchanging information with the second computer via encrypted communication.

50. The method according to claim 49, wherein the encrypted communication is adapted to use keys stored in the secured partition.

51. The method according to claim 40, further comprising allowing any one of the secure tasks in said predefined set to access the secured partition.

52. A security system for securing data stored in a secured partition of a storage device from access by an unauthorized third party such as an unauthorized human operator or an unauthorized remote computer, the security system comprising:
a computer to which the storage device is coupled;
a secure operating system, operating on the computer, which is adapted to operate only secure tasks which are members of a predefined set of secure tasks, comprising at least one secure task for providing security against hostile software;
an insecure operating system subservient to the secure operating system operating on the computer;
an access controller for detecting access to the secured partition;
an interrupt generator coupled to said access controller and being responsive to access detection for generating an interrupt for interrupting the secure operating system;
an interrupt handler responsive to the interrupt for preempting the insecure operating system and tasks being subservient thereto, thereby preventing them from accessing the secured partition; and
a secure task which is activated after said preemption of the insecure operating system, for determining if the third party is an authorized third party.

53. The security system according to claim 52, wherein the set of secure tasks may contain a configuration task for reconfiguration of the set of secure tasks by a privileged operator such as a system administrator.

54. The security system according to claim 52, wherein the secure operating system includes an interaction unit for interacting with a third party, said interaction unit includes an input-receiving unit for receiving information from the third party and an output conveying unit for conveying information to a third party.

55. The security system according to claim 54, wherein the input receiving unit is a user interface or a network interface card or a modem.

56. The security system according to claim 55, further comprising a decryption unit coupled to said input receiving unit for decrypting the information after receiving it from the third party and prior to its being conveyed to any one of the secure tasks in said predefined set.

57. The security system according to claim 54, wherein the output conveying unit is a user interface or a network interface card or a modem.

58. The security system according to claim 57, further comprising an encryption unit coupled to the output-conveying unit for encrypting the information prior to its being conveyed to the third party.
